(19) United States
(12) Patent Application Publication
(10) Pub. No.: US 2013/0208483 A1
(43) Pub. Date: Aug. 15, 2013

(54) LIGHT EMITTING DEVICE

(71) Applicant: Edison Opto Corporation, (US)

(72) Inventors: Hung-Hsun CHOU, New Taipei City (TW); Chih-Wei HSU, New Taipei City (TW)

(73) Assignee: EDISON OPTO CORPORATION, New Taipei City (TW)

(21) Appl. No.: 13/756,508

(22) Filed: Jan. 31, 2013

(30) Foreign Application Priority Data
Feb. 14, 2012 (TW) 101104750

(51) Int. Cl. F21V 19/00

(52) U.S. Cl. CPC F21V 19/0035
USPC 362/294; 362/382; 362/363

(57) ABSTRACT

A light emitting device includes a socket ring including a support portion and a first side wall, a light source module, and a bottom holder including a fixing portion and a second side wall. The support portion has a first surface and a second surface opposite to the first surface. The first side wall is perpendicular to the second surface. A first thread and at least one heat dissipating fin are formed on the first side wall. The first thread and the heat dissipating fin are respectively located on an inner surface and an outer surface of the first side wall. The second side wall stands erect on the fixing portion, and has a second thread coupled to the first thread.

### RELATED APPLICATIONS

This application claims priority to Taiwan Application Ser. No. 101104750, filed Feb. 14, 2012, which is herein incorporated by reference.

### BACKGROUND

1. Technical Field

The present disclosure relates to a light emitting device, and more particularly a light emitting device used in a lighting apparatus.

2. Description of Related Art

Lighting devices are indispensable in our daily lives. Conventional lighting devices include light bulbs or tubes which are used as the light sources therein. Fluorescent tubes, incandescent bulbs, halogen fluorescent tubes or halogen light bulbs are typically used for such light bulbs or tubes. However, these light sources consume a lot of electrical energy during operation.

The light emitting diode (LED) is a semiconductor element. Previously, LEDs were used primarily as light emitting elements in indicating lights or display panels of electronic devices. However, in recent years, light emitting diodes have also been applied to lighting devices. When LEDs are used as light sources of lighting devices, the resulting LED lighting devices have the advantages of long life span, low power consumption, small size, good shock resistance, and the ability to be used over a wide range of applications compared to lighting devices using traditional incandescent bulbs. Moreover, LEDs do not easily shatter as in the case of traditional incandescent bulbs for example, when dropped), so that lighting devices utilizing LEDs can provide safety for users.

However, after using LEDs for a period of time, heat may be accumulated in electric components adjacent to the LEDs, leading to deterioration and light attenuation problems. As a result, the light efficiency of the LEDs is decreased, and when the temperature of the LEDs is too high, electric components (e.g., printed circuit boards for driving the LEDs) may be damaged.

A conventional LED pendent lamp may include an electric light, a light cover, a light cover fixing ring (i.e., a socket ring), a light holder, and a heat dissipating block (e.g., a heat sink). The electric light is located on the light holder, and the light cover is fixed on the light holder by the light cover fixing ring. The heat dissipating block contacts the light holder so as to dissipate heat generated by the electric light.

In such a conventional LED pendent lamp, although the heat dissipating block can be utilized to dissipate heat, the heat dissipating block is an independent element, and so occupies space. Moreover, the light cover fixing ring functions only to fix the light cover and therefore increases overall costs while providing only a minimal benefit. In addition, since there are a variety of different types of components in the conventional LED pendent lamp, the assembly time and material costs of the conventional LED pendent lamp are increased, and limitations are encountered with respect to varying the design of the conventional LED pendent lamp.

### SUMMARY

An aspect of the present invention is to provide a light emitting device.

In an embodiment of the present invention, a light emitting device includes a socket ring, a light source module, and a bottom holder. The socket ring includes a support portion and a first side wall. The support portion has a first surface and a second surface opposite to the first surface. The first side wall is substantially perpendicular to the second surface. A first accommodating space is formed between the first side wall and the support portion. A first thread and at least one heat dissipating fin are formed on the first side wall. The first thread is located on an inner surface of the first side wall and extends toward the first accommodating space. The heat dissipating fin is located on an outer surface of the first side wall. The light source module is located on the first surface. The bottom holder includes a fixing portion and a second side wall. The second side wall stands erect on the fixing portion. A second accommodating space is formed between the second side wall and the fixing portion. The second side wall has a second thread coupled to the first thread, such that a portion of the bottom holder is located in the first accommodating space.

In an embodiment of the present invention, the light source module includes a light source and a light transmissive lid. The light source is mounted on the first surface. The light transmissive lid covers the light source and is fixed on the first surface, such that the light transmissive lid emits a light formed by the light source.

In an embodiment of the present invention, the light source includes a light emitting diode.

In an embodiment of the present invention, the light transmissive lid includes an optical lens, a light transmissive lampshade, or a combination thereof.

In an embodiment of the present invention, the light emitting device includes a first wire assembly and a second wire assembly. The first wire assembly is located in the first accommodating space, and is electrically connected to the light source. The second wire assembly is located in the second accommodating space, and is electrically connected to the first wire assembly.

In an embodiment of the present nvention, two first through holes are formed on the first surface, and the first wire assembly includes two first wires and a first connector. The two first wires are respectively passed through the two first through holes and respectively connected to a positive electrode and a negative electrode of the light source. The first connector sleeved on the two first wires.

In an embodiment of the present invention, two second through holes are formed on the fixing portion, and the second wire assembly includes two second wires and a second connector. The two second wires are respectively passed through the two second through holes and electrically connected to a power supply device of a lighting apparatus. The second connector is sleeved on the two second wires and coupled to the first connector.

In an embodiment of the present invention, the number of the heat dissipating fin is plural, and the heat dissipating fins are in substantially parallel arrangement.

In an embodiment of the present invention, cross-sectional shapes of the first and second side walls are round, and an inner diameter of the first side wall is larger than an outer diameter of the second side wall.

In an embodiment of the present invention, the socket ring is made of a material that includes iron, aluminum, thermally conductive plastic, or ceramic.

In an embodiment of the present invention, the first and second threads are respectively internal and external threads coupled with each other, such that the socket ring is coupled to the bottom holder.

In the aforementioned embodiments of the present invention, since the socket ring can be coupled to the bottom holder by the first thread of the socket ring and the second thread of the bottom holder, the socket ring can be assembled to the bottom holder. Furthermore, the first side wall of the socket ring has the heat dissipating fin, so that heat generated by the light source module which is located on the support portion of the socket ring can be dissipated by the heat dissipating fin of the first side wall. Moreover, the light transmissive lid covers the light source and is fixed on the first surface of the support portion, such that the light transmissive lid emits a light formed by the light source. Therefore, the socket ring of the light emitting device not only functions to support the light transmissive lid and the light source, and to fix a decorative lampshade, but also functions to assemble the bottom holder. More importantly, the heat generated by the light source module can be dissipated from the socket ring through the heat dissipating fin. In contrast to a conventional LED pendent lamp, the socket ring of the light emitting device of the present invention can replace a conventional heat dissipating block and a conventional socket ring separated from the heat dissipating block, so that the number of components of the light emitting device is smaller than the number of components found in a conventional LED pendent lamp. As a result, the assembly time and material cost of the light emitting device can be reduced. Furthermore, increased freedom of design can be realized with respect to a lighting apparatus including the light emitting device.

### BRIEF DESCRIPTION OF THE DRAWINGS

FIG. 1 is a perspective view of a light emitting device according to an embodiment of the present invention;

FIG. 2 is an exploded view of the light emitting device shown in FIG. 1;

FIG. 3A is a schematic view of a light transmissive lid shown in FIG. 2 of an embodiment of the present invention;

FIG. 3B is a schematic view of the light transmissive lid shown in FIG. 2 of an embodiment of the present invention;

FIG. 3C is a schematic view of the light transmissive lid shown in FIG. 2 of an embodiment of the present invention;

FIG. 4 is a perspective view of a socket ring, a light source module, and a first wire assembly shown in FIG. 2 after being assembled;

FIG. 5 is a side view of the socket ring, the light source module, and the first wire assembly shown in FIG. 2 after being assembled;

FIG. 6 is a perspective view of a bottom holder and a second wire assembly shown in FIG. 2 after being assembled;

FIG. 7 is a bottom view of the bottom holder and the second wire assembly shown in FIG. 2 after being assembled; and

FIG. 8 is a schematic view of the light emitting device shown in FIG. 1 in a state assembled to a lighting apparatus.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

It is to be noted that “substantially” used herein may refer to variances occurring due to manufacturing errors, such as a 10% error, but the present invention is not limited in this regard.

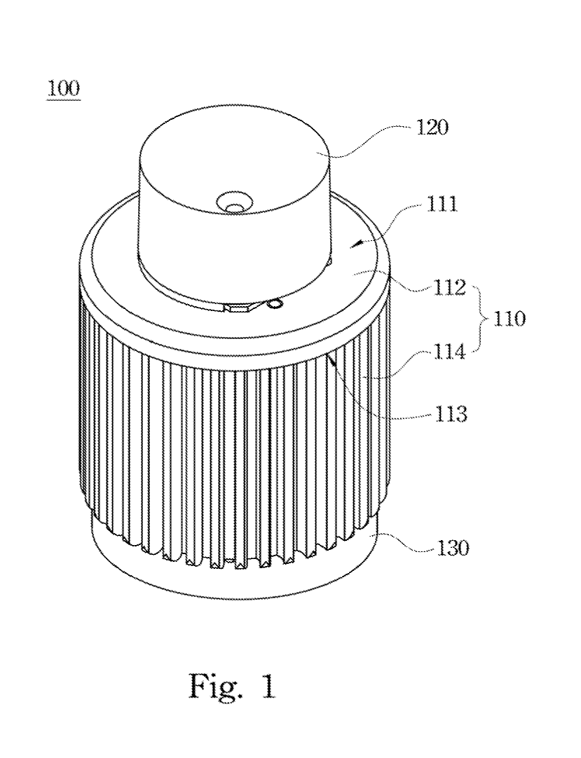

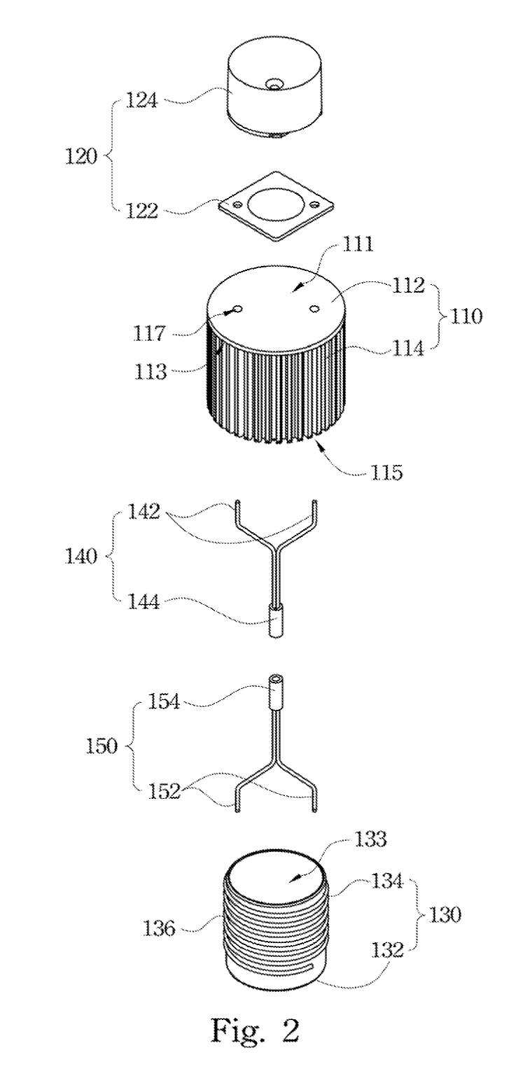

FIG. 1 is a perspective view of a light emitting device 100 according to an embodiment of the present invention. FIG. 2 is an exploded view of the light emitting device 100 shown in FIG. 1. As shown in FIG. 1 and FIG. 2, the light emitting device 100 includes a socket ring 110, a light source module 120, and a bottom holder 130. The socket ring 110 includes a support portion 112 and a first side wall 114. The support portion 112 has a first surface 111 and a second surface 113 opposite to the first surface 111. The first side wall 114 is substantially perpendicular to the second surface 113, and a first accommodating space 115 is formed between the first side wall 114 and the support portion 112. The bottom holder 130 includes a fixing portion 132 and a second side wall 134. The second side wall 134 stands erect on the fixing portion 132, and a second accommodating space 133 is formed between the second side wall 134 and the fixing portion 132.

The light source module 120 is located on the first surface 111, and includes a light source 122 and a light transmissive lid 124. The light source 122 is mounted on the first surface 111. The light transmissive lid 124 covers the light source 122 and is fixed on the first surface 111, such that the light transmissive lid 124 can emit a light formed by the light source 122. The light source 122 can be arranged on the first surface 111 by screwing or adhering the light source 122 on the first surface 111, and the light transmissive lid 124 can be arranged on the first surface 111 by adhering, fastening, or coupling (e.g., rotatable coupling) the light transmissive lid 124 on the first surface 111.

Moreover, the light emitting device 100 may further include a first wire assembly 140 and a second wire assembly 150. The first wire assembly 140 is located in the first accommodating space 115, and is electrically connected to the light source 122. The second wire assembly 150 is located in the second accommodating space 133, and is electrically connected to the first wire assembly 140. More specifically, two first through holes 117 are formed on the first surface 111 of the support portion 112, and the first wire assembly 140 includes two first wires 142 and a first connector 144. The two first wires 142 can be respectively passed through the two first through holes 117 and respectively connected to a positive electrode and a negative electrode of the light source 122, and the first connector 144 is sleeved on the two first wires 142, such that the two first wires 142 are disposed partly in the first connector 144. Furthermore, the second wire assembly 150 includes two second wires 152 and a second connector 154. The second connector 154 is sleeved on the two second wires 152, such that the two second wires 152 are disposed partly in the second connector 154. The second connector 154 is coupled to the first connector 144.

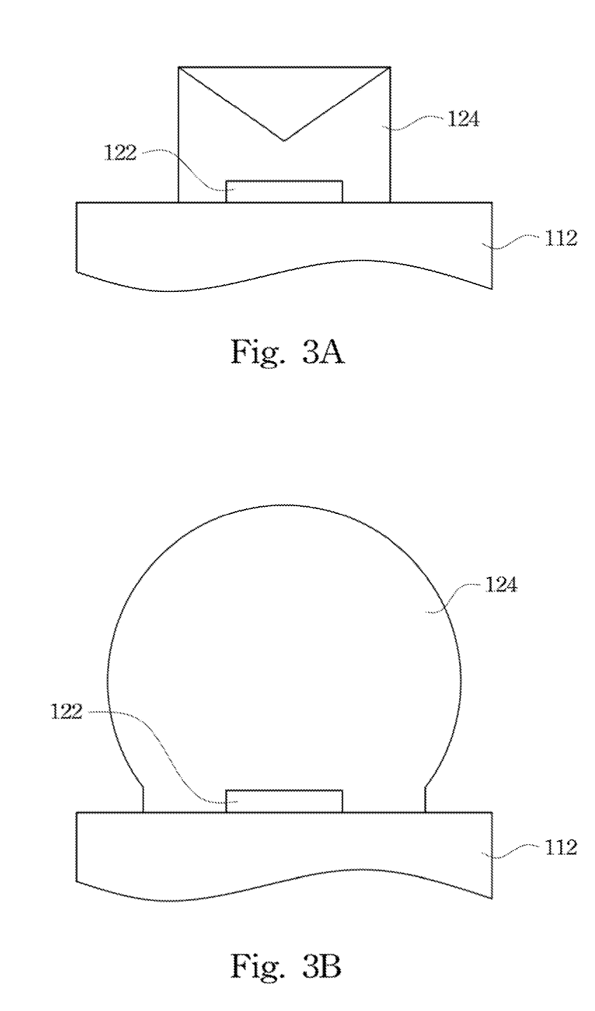

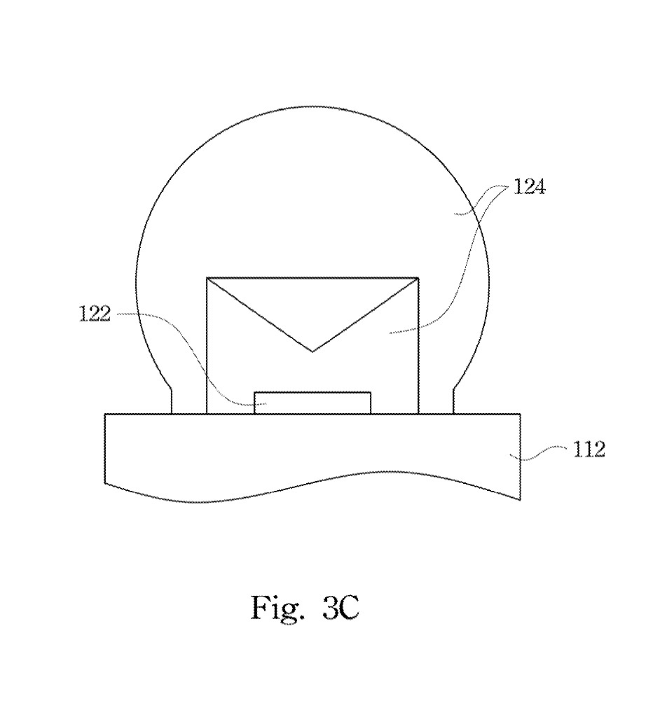

In this embodiment, the light source 122 may be a light emitting diode, and the light transmissive lid 124 may be an optical lens shown in FIG. 3A, a light transmissive lampshade shown in FIG. 3B, or a combination thereof shown in FIG. 3C. The socket ring 110 may be made of a material that includes iron, aluminum, other thermally conductive metals, thermally conductive plastic, or ceramic. The bottom holder 130 may be made of a material that includes iron, aluminum, other thermally conductive metals, ceramic, or thermally conductive plastic. That is, the materials of the socket ring 110 and the bottom holder 130 may be the same.

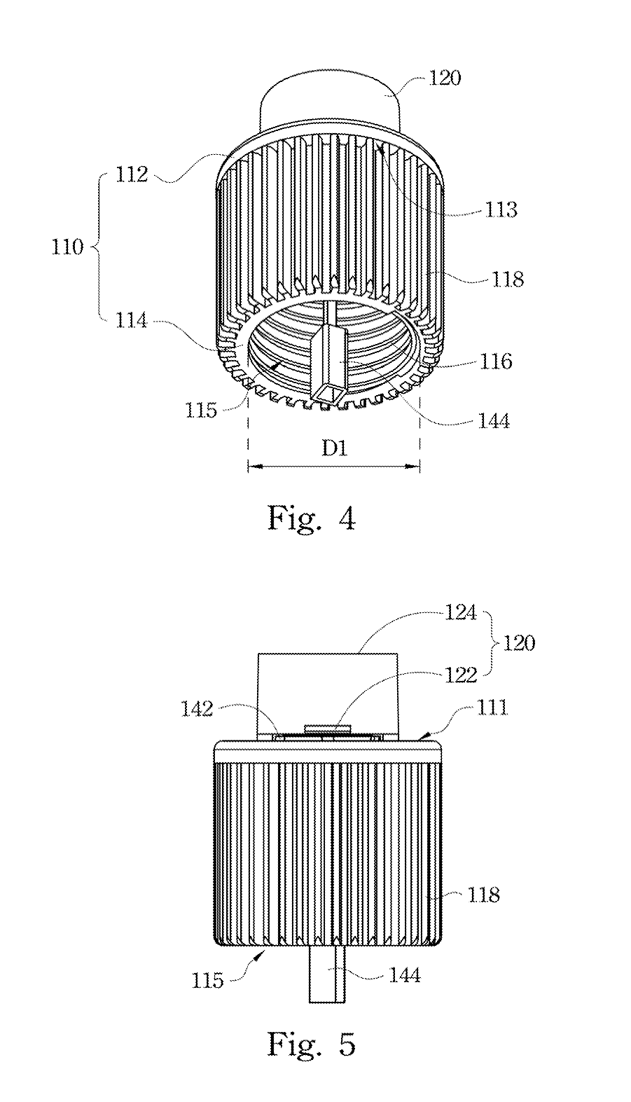

FIG. 4 is a perspective view of the socket ring 110, the light source odule 120, and the first wire assembly 140 shown in FIG. 2 after being assembled. FIG. 5 is a side view of the socket ring 110, the light source module 120, and the first wire assembly 140 shown in FIG. 2 after being assembled. In the following description, an inner surface of the first side wall 114 means a surface that faces the first accommodating space 115, and an outer surface of the first side wall 114 means a surface that faces away from the first accommodating space 115. As shown in FIG. 4 and FIG. 5, a first thread 116 and a plurality of heat dissipating fins 118 are formed on the first side wall 114 of the socket ring 110. The first thread 116 is located on the inner surface of the first side wall 114 and extends toward the first accommodating space 115. The heat dissipating fins 118 are located on the outer surface of the first side wall 114. In this embodiment, the number of the heat dissipating fins 118 is plural, and the heat dissipating fins 118 are in substantially parallel arrangement.

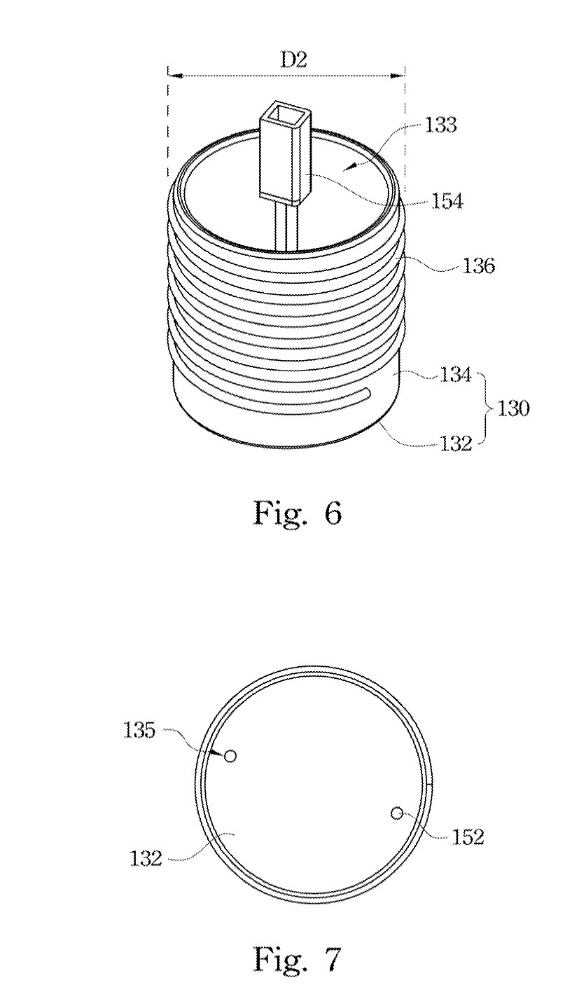

FIG. 6 is a perspective view of the bottom holder 130 and the second wire assembly 150 shown in FIG. 2 after being assembled. As shown in FIG. 4 and FIG. 6, cross-sectional shapes of the first side wall 114 of the socket ring 110 and the second side wall 134 of the bottom holder 130 may be round, and an inner diameter D1 of the first side wall 114 is larger than an outer diameter D2 of the second side wall 134. Furthermore, the second side wall 134 has a second thread 136, and the second thread 136 can be coupled to the first thread 116. That is to say, the first and second threads 116, 136 are respectively internal and external threads coupled with each other. As a result, when the second thread 136 of the bottom holder 130 is coupled to the first thread 116 of the socket ring 110, a portion of the bottom holder 130 can be located in the first accommodating space 115.

During assembly, the first connector 144 can be coupled to the second connector 154 first. Next, the first thread 116 of the socket ring 110 can be coupled to the second thread 136 of the bottom holder 130. When the light source module 120 located on the support portion 112 is operating, heat generated by the light source module 120 can be dissipated by the heat dissipating fins 118 disposed on the first side wall 114 of the socket ring 110.

It is to be noted that a description of the connection relationship and materials of the aforementioned elements will not be repeated. In the following, the light emitting device 100 is described in a state assembled to a lighting apparatus.

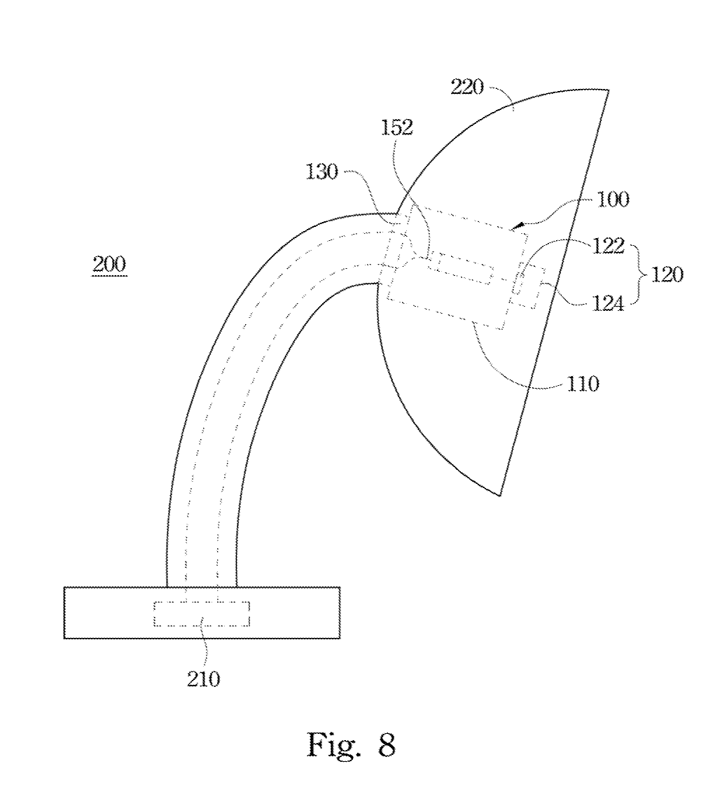

FIG. 7 is a bottom view of the bottom holder 130 and the second wire assembly 150 shown in FIG. 2 after being assembled. FIG. 8 is a schematic view of the light emitting device 100 shown in FIG. 1 in a state assembled to a lighting apparatus 200. As shown in FIG. 7 and FIG. 8, two second through holes 135 are formed on the fixing portion 132, such that the two second wires 152 can be respectivelyy passed through the two second through holes 135 and electrically connected to a power supply device of the lighting apparatus 200. For example, the two second wires 152 may be electrically connected to a transformer 210 of the lighting apparatus 200. The fixing portion 132 may be fixed on the lighting apparatus 200 by adhering or screwing the fixing portion 132 on the lighting apparatus 200, and a decorative lampshade 220 may be fixed on the bottom holder 130, which is exposed from the socket ring 110 by adhering, fastening or screwing the decorative lampshade 220 on the bottom holder 130. When the power supply device (e.g., the transformer 210) of the lighting apparatus 200 provides electricity, the light source module 120 can be operated, and the heat generated by the light source module 120 can be dissipated through the heat dissipating fins 118 (see FIG. 5) of the socket ring 110. Moreover, increased freedom of design can be realized with respect to the lighting apparatus 200 including the light emitting device 100.

The socket ring 110 of the light emitting device 100 not only functions to support the light transmissive lid 124 and the light source 122, and to fix the decorative lampshade 220, but also functions to assemble the bottom holder 130. Moreover, the heat generated by the light source 122 can be dissipated through the heat dissipating fins 118 (see FIG. 4) of the socket ring 110. As a result, the socket ring 110 of the light emitting device 100 of the present invention can replace a conventional heat dissipating block and a conventional socket ring separated from the heat dissipating block of a conventional LED pendent lamp, so that the number of components of the light emitting device 100 is smaller than the number of components found in the conventional LED pendent lamp. Therefore, the assembly time and material cost of the light emitting device 100 can be reduced.

In contrast to the conventional LED pendent lamp, the socket ring can be coupled to the bottom holder by the first thread of the socket ring and the second thread of the bottom holder, such that the socket ring can be assembled to the bottom holder. Furthermore, the light transmissive lid covers the light source and is fixed on the first surface of the support portion, such that the light transmissive lid emits a light formed by the light source. The first side wall of the socket ring has the heat dissipating fins, so that heat generated by the light source module which is located on the support portion of the socket ring can be dissipated by the heat dissipating fins of the first side wall. The socket ring of the light emitting device of the present invention can replace the conventional heat dissipating block and the conventional socket ring separated from the heat dissipating block, so that the number of components of the light emitting device is smaller than the number of components found in the conventional LED pendent lamp. As a result, the assembly time and material cost of the light emitting device can be reduced. Furthermore, increased freedom of design can be realized with respect to the lighting apparatus including the light emitting device.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A light emitting device comprising:
a socket ring comprising:
a support portion having a first surface and a second surface opposite to the first surface; and
a first side wall substantially perpendicular to the second surface, and a first accommodating space formed between the first side wall and the support portion, wherein a first thread and at least one heat dissipating fin are formed on the first side wall, the first thread is located on an inner surface of the first side wall and extends toward the first accommodating space, and the heat dissipating fin is located on an outer surface of the first side wall;
a light source module located on the first surface; and
a bottom holder comprising:
a fixing portion; and
a second side wall standing erect on the fixing portion, and a second accommodating space formed between the second side wall and the fixing portion, wherein the second side wall has a second thread coupled to the first thread, such that a portion of the bottom holder is located in the first accommodating space.

2. The light emitting device as claimed in claim 1, wherein the light source module comprises:
a light source mounted on the first surface; and
a light transmissive lid covering the light source and fixed on the first surface, such that the light transmissive lid emits a light formed by the light source.

3. The light emitting device as claimed in claim 2, wherein the light source comprises a light emitting diode.

4. The light emitting device as claimed in claim 2, wherein the light transmissive lid comprises an optical lens, a light transmissive lampshade, or a combination thereof.

5. The light emitting device as claimed in claim 2, further comprising:
a first wire assembly located in the first accommodating space and electrically connected to the light source; and
a second wire assembly located in the second accommodating space and electrically connected to the first wire assembly.

6. The light emitting device as claimed in claim 5, wherein two first through holes are formed on the first surface, and the first wire assembly comprises:
two first wires respectively passed through the two first through holes and respectively connected to a positive electrode and a negative electrode of the light source; and
a first connector sleeved on the two first wires.

7. The light emitting device as claimed in claim 6, wherein two second through holes are formed on the fixing portion, and the second wire assembly comprises:
two second wires respectively passed through the two second through holes and electrically connected to a power supply device of a lighting apparatus; and
a second connector sleeved on the two second wires and coupled to the first connector.

8. The light emitting device as claimed in claim 1, wherein the number of the heat dissipating fin is plural, and the heat dissipating fins are in substantially parallel arrangement.

9. The light emitting device as claimed in claim 1, wherein cross-sectional shapes of the first and second side walls are round, and an inner diameter of the first side wall is larger than an outer diameter of the second side wall.

10. The light emitting device as claimed in claim 1, wherein the first and second threads are respectively internal and external threads coupled with each other, such that the socket ring is coupled to the bottom holder.
